(19) United States
(12) Patent Application Publication
(10) Pub. No.: US 2026/0066326 A1
(43) Pub. Date: Mar. 5, 2026

(54) Ionic Coulomb Drag in Nanofluidic Semiconductor Channels for Energy Harvest

(71) Applicant: The Board of Trustees of the University of Illinois, Urbana, IL (US)

(72) Inventors: Mingye Xiong, Santa Clara, CA (US); Jean-Pierre Leburton, Champaign, IL (US)

(21) Appl. No.: 19/314,373

(22) Filed: Aug. 29, 2025

Related U.S. Application Data
(60) Provisional application No. 63/689,255, filed on Aug. 30, 2024.

(51) Int. Cl. H01M 8/22; H01M 8/1016; H01M 8/102

(52) U.S. Cl. CPC H01M 8/227; H01M 8/1016; H01M 8/102; H01M 2300/0068; H01M 2300/0082

(57) ABSTRACT

Devices and methods are provided. An example device includes a dielectric having a channel extending from a first end of the dielectric to a second end of the dielectric. A first end of the channel is at the first end of the dielectric and a second end of the channel is at the second end of the dielectric. The device also includes a membrane on an exterior side of the dielectric that does not interface with the channel. Additionally, the device includes a first chamber, fluidly coupled to the first end of the channel, and a second chamber, fluidly coupled to the second end of the channel. When a fluid distributed among the first chamber, the channel, and the second chamber exhibits an ionic concentration gradient between the first chamber and the second chamber causing an ionic flow, an electric current is generated within the membrane.

### CROSS-REFERENCE TO RELATED APPLICATIONS

This is application claims the benefit of U.S. Provisional Patent Application No. 63/689,255, filed August 30, 2024. Priority to U.S. Provisional Patent Application No. 63/689,255 is hereby claimed. U.S. Provisional Patent Application No. 63/689,255 is hereby incorporated by reference in its entirety.

### BACKGROUND

The development of nanotechnology and nanofluidics enables channels made of solid-state materials on the scale of a few nanometers. Coulomb drag is a nanoscale transport phenomenon observed when electric currents in “active” conducting layers drive electric charge carriers in “passive” layers that are a few nanometers to tens of nanometers apart. This is the result of the effective range of the Coulomb interactions.

The present disclosure relates to devices and methods used to generate electric currents in membranes. This can be through ionic Coulomb drag.

In a first aspect, a device is described. The device includes a dielectric having a channel defined therein that extends from a first end of the dielectric to a second end of the dielectric. A first end of the channel is located at the first end of the dielectric and a second end of the channel is located at the second end of the dielectric. The device also includes a membrane located on an exterior side of the dielectric such that the membrane does not interface with the channel. Further, the device includes a first chamber fluidly coupled to the first end of the channel. In addition, the device includes a second chamber fluidly coupled to the second end of the channel. When a fluid distributed among the first chamber, the channel, and the second chamber exhibits an ionic concentration gradient between the first chamber and the second chamber resulting in an ionic flow, an electric current is generated within the membrane.

In a second aspect, a device is described. The device includes a first dielectric and a second dielectric separated from the first dielectric by a distance defining a channel. The channel runs from a first end to a second end. The device also includes a first membrane located on an exterior side of the first dielectric such that the first membrane does not interface with the channel. Further, the device also includes a second membrane located on an exterior side of the second dielectric such that the second membrane does not interface with the channel. Moreover, the device also includes a first chamber fluidly coupled to the first end of the channel. In addition, the device also includes a second chamber fluidly coupled to the second end of the channel. When a fluid distributed among the first chamber, the channel, and the second chamber exhibits an ionic concentration gradient between the first chamber and the second chamber resulting in an ionic flow, an electric current is generated within the first membrane or the second membrane.

In a third aspect, a method is described. The method includes distributing a fluid among a first chamber, a channel, and a second chamber. The first chamber is fluidly coupled to a first end of the channel and the second chamber is fluidly coupled to a second end of the channel. The fluid exhibits an ionic concentration gradient between the first chamber and the second chamber resulting in an ionic flow. The method also includes generating an electric current within a membrane based on the ionic flow. The membrane is located on an exterior side of an dielectric in which the channel is defined such that the membrane does not interface with the channel. Also, the first end of the channel is located at a first end of the dielectric and the second end of the channel is located at the second end of the dielectric.

Other aspects, embodiments, and implementations will become apparent to those of ordinary skill in the art by reading the following detailed description, with reference where appropriate to the accompanying drawings.

### BRIEF DESCRIPTION OF THE FIGURES

The embodiments may be better understood with reference to the following drawings and description. The components in the figures are not necessarily to scale. Moreover, in the figures, like-referenced numerals designate corresponding parts throughout the different views.

FIG. 1A is a cross-sectional illustration of a device, according to example embodiments.

FIG. 1B is an isometric illustration of the device of FIG. 1A, according to example embodiments.

FIG. 1C is an isometric illustration of the device of FIG. 1A, according to example embodiments.

FIG. 1D is an isometric illustration of the device of FIG. 1A, according to example embodiments.

FIG. 1E is an isometric illustration of the device of FIG. 1A, according to example embodiments.

FIG. 1F is an isometric illustration of the device of FIG. 1A, according to example embodiments.

FIG. 1G is an isometric illustration of the device of FIG. 1A, according to example embodiments.

FIG. 2A is a cross-sectional illustration of a device, according to example embodiments.

FIG. 2B is an isometric illustration of the device of FIG. 2A, according to example embodiments.

FIG. 3 is a cross-sectional illustration of a device, according to example embodiments.

FIG. 4 is a cross-sectional illustration of a device, according to example embodiments.

FIG. 5 is a flowchart illustration of a method, according to example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

The present disclosure relates to devices and methods used to generate electric currents in membranes through ionic Coulomb drag. Advances in nanotechnology and nanofluidics have enabled the creation of channels made of solid-state materials on the scale of a few nanometers. Even sub-nanometer scale channels are possible. Such channels enable the study and exploitation of nanoscale-level ionic transport properties and both electrical and mechanical interactions between nanoscale channel fluidics and their environments.

Embodiments herein, for example, may make use of ion−electron Coulomb drag. This effect may manifest as a mutual electrostatic influence between mobile ions and electrons (or holes) in a surrounding material. Further, this effect may result in correlated particle motion, which can affect the overall transport characteristics of both ions and electrons (or holes). As ions move through nanosized channels within a material, a dynamic Coulomb effect may take place between the surrounding material and the inherent charge carriers. This dynamic Coulomb effect may then cause the “dragging” of the charge carriers, resulting in an electric current inside the surrounding material. Ion-electron Coulomb drag may be used for many purposes (e.g., energy harvesting from salinity gradient ion flow detection and sensing and simultaneous tuning of electronic and ionic transport).

As noted above, ionic Coulomb drag could provide a new approach to osmotic power harvest by extracting energy stored in the salinity gradient between seawater and freshwater, thereby complementing current methodologies, such as pressure retarded osmosis and reverse electrodialysis (RED). Aside from large-scale energy conversion, ionic Coulomb drag also has potential applications in power sources for small-scale, self-supplied devices in ionic aqueous environments, such as ion flow detectors or other sensors. There are multiple considerations when designing systems that exploit ionic Coulomb drag. As such, example embodiments incorporate an in-depth analysis of design factors, such as structure geometry and material selections, while making use of ion−electron Coulomb drag effect.

Regarding nanochannels designed to extract power from ionic Coulomb drag, multiple geometries are promising. Two of these are cylindrical nanochannels and 2D nanoslits. Compared to cylindrical nanochannels, 2D nanoslits offer advantages, including straightforward fabrication processes, cleaner and more controlled channel surfaces, a broader range of material options, and the potential to achieve large-scale integration.

However, there is a lack of a richly developed theoretical framework of ionic Coulomb drag in solid-state nanochannels. Such a framework may enable the determination of multiple nanochannel properties without the need to physically construct the nanochannel. Such a model may be able to determine current amplification and provide guidelines on nanochannel designs, such as material selection and circuitry design optimization. Such guidelines may be used to maximize the drag current and power output.

An example device may include a channel defined within a dielectric, which is at least partially enclosed by a membrane. The channel may be connected to two chambers, with one chamber attached to each end of the channel. If fluids are placed into each of the two chambers, the fluids may be allowed to mix (e.g., move from one chamber, through the channel, to the other chamber). If one chamber contains a fluid with a higher concentration of ions, such as salt water, and the other chamber contains a fluid with a lower concentration of ions, such as freshwater, ions may diffuse from one chamber to the other chamber through the channel. Since the ions have a polarity, either positive or negative, the combined motion of the ions from one chamber to the other chamber may produce a net current through the channel. This ionic current may produce a corresponding electromagnetic field, which results in a corresponding electric current in nearby portions of the membrane (e.g., a drag current).

There is electric energy present in the previously described electric current that can be harvested, such as by connecting separate electrodes to each end of the membrane and using the electric current produced within the membrane to charge a battery.

Since the strength of the electromagnetic field decreases with distance, reducing the dielectric thickness may increase the amount of electric energy extracted from the electromagnetic field. The thicknesses of the dielectric layer may be less than 1 nm. For example, the thicknesses of the dielectric layer may range from approximately 0.34 nm to approximately 0.8 nm. In some embodiments, the dielectric layer may even be non-existent (i.e., there may be no dielectric layer whatsoever). In such embodiments, the channel may be in contact with the membrane. For example, the membrane could be formed from carbon nanotubes.

The dielectric layer may form based, in part, on the interaction between the fluid and the membrane For example, the dielectric layer may be an oxide that forms based on an oxidation reaction between the fluid and the membrane.

In addition, if the membrane is a semiconductor, the doping of the membrane may affect the efficiency of the previously described device. For example, if the membrane is a semiconductor, p-type doping of the membrane may result in positive charges accumulating on the surface of the dielectric, which could attract negative charge carriers and repel positive charge carriers. This may increase the ionic current in the channel via the movement of negative charge carriers in the fluid.

In some cases, multiple channels connected to the same two chambers or different chambers may be used to further scale the amount of energy extracted. For example, energy could be extracted from each channel in such a system.

### II. Example Devices

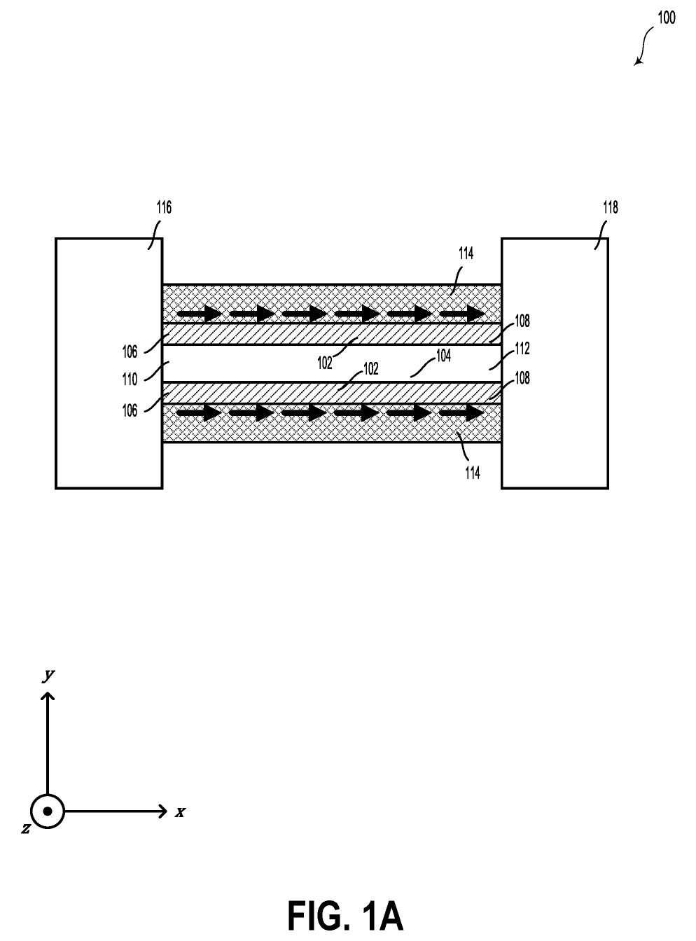

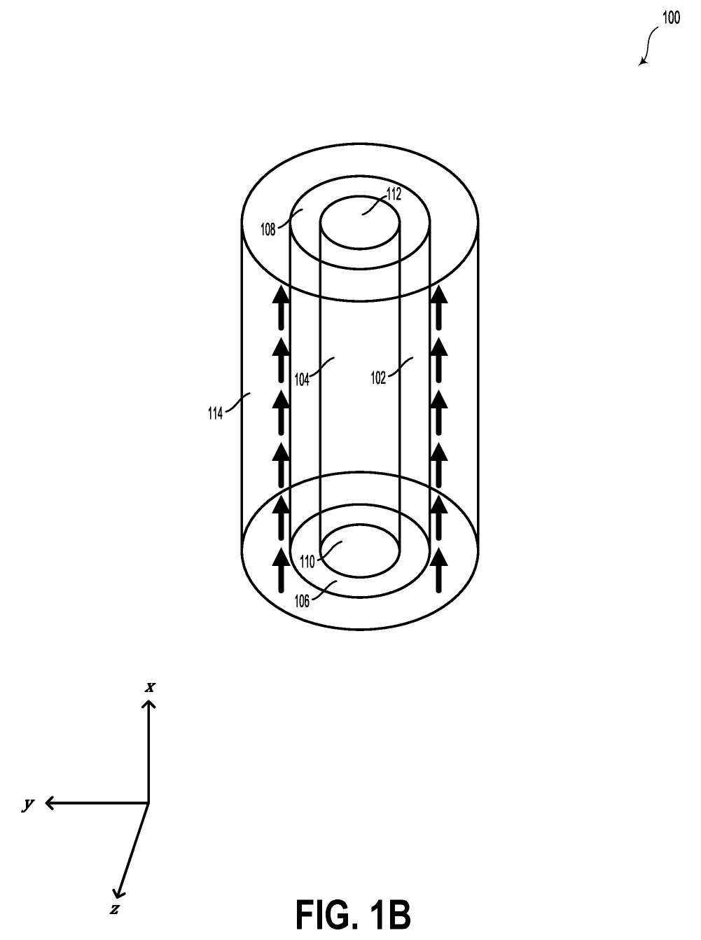

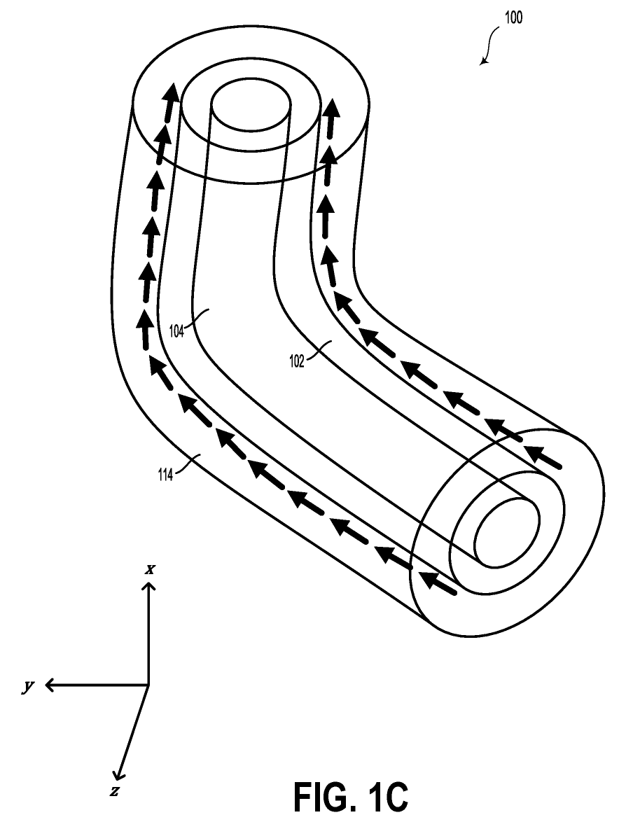

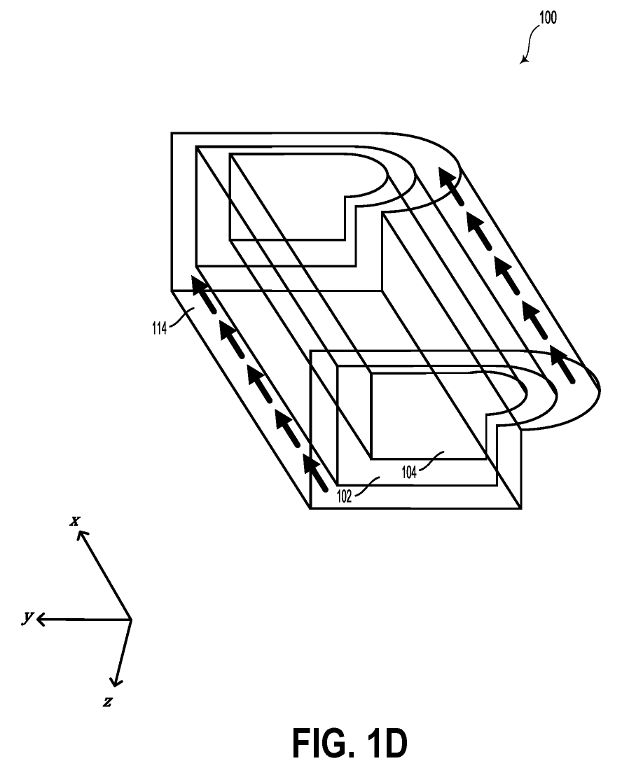

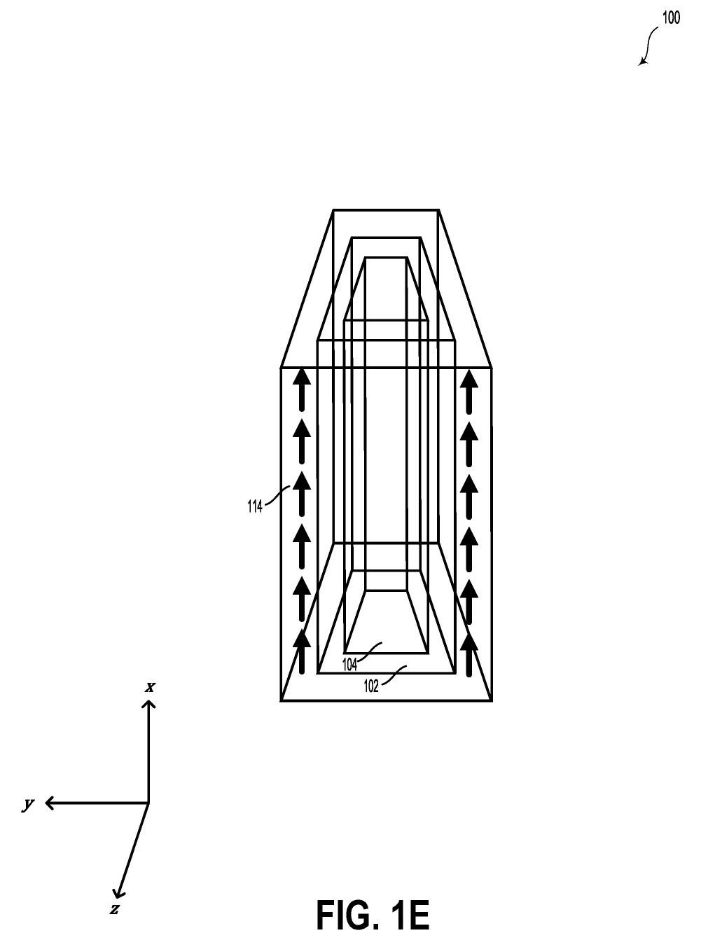

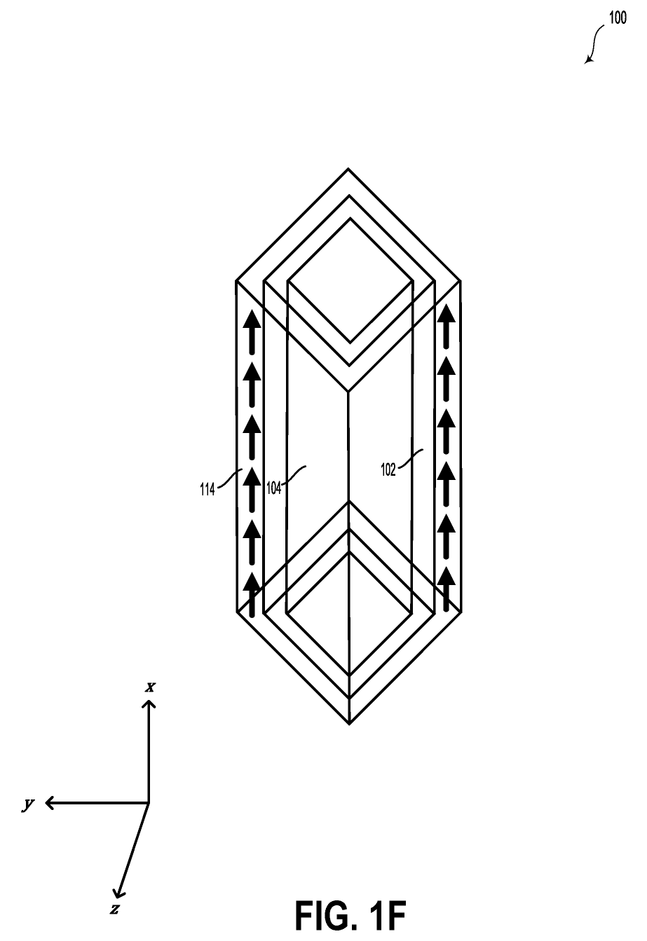

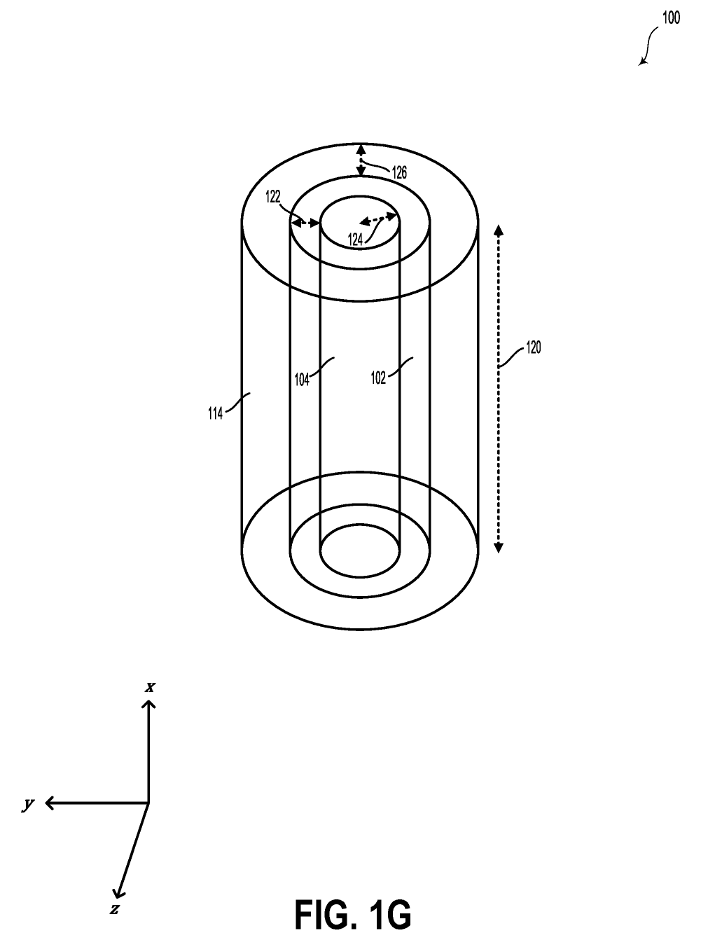

FIG. 1A is a cross-sectional illustration of a device 100, according to example embodiments. As illustrated, the device 100 may include a dielectric 102 having a channel 104 defined therein that extends from a first end 106 of the dielectric 102 to a second end 108 of the dielectric 102, wherein a first end 110 of the channel 104 may be located at the first end 106 of the dielectric 102 and a second end 112 of the channel 104 may be located at the second end 108 of the dielectric 102. Device 100 may also include a membrane 114 located on an exterior side of the dielectric 102 such that the membrane 114 does not interface with the channel 104. Moreover, device 100 may include a first chamber 116 fluidly coupled to the first end 110 of the channel 104 and a second chamber 118 fluidly coupled to the second end 112 of the channel 104. When a fluid distributed among the first chamber 116, the channel 104, and the second chamber 118 exhibits an ionic concentration gradient between the first chamber 116 and the second chamber 118 resulting in an ionic flow (e.g., as a result of ionic diffusion), an electric current may be generated within the membrane 114. In FIG. 1A, the electric current is illustrated by the arrows within the membrane 114 near the interface between the membrane 114 and the dielectric 102. In some embodiments, the electric current may flow in the opposite direction (e.g., from the second chamber 118 to the first chamber 116) depending on the direction of movement and/or the polarity of the minority carriers in the membrane 114.

In some embodiments, the ionic flow may be ionic diffusion flow. In some embodiments, the ionic flow may be produced as a result of an oxidation-reduction reaction.

In some embodiments, a first end of the membrane 114 may be located at the first end 106 of the dielectric 102 and a second end of the membrane 114 may be located at the second end 108 of the dielectric 102. In some embodiments, device 100 may also include a first electrode electrically coupled to the first end of the membrane 114. In some embodiments, device 100 may also include a second electrode electrically coupled to the second end of the membrane 114. In some embodiments, when the electric current is generated within the membrane 114, a drag current and a drag voltage may be generated between the first electrode and the second electrode.

FIG. 1B is an isometric illustration of the device 100 of FIG. 1A, according to example embodiments. As illustrated, device 100 (and its components) may be cylindrical (i.e., the channel 104 may be cylindrical, the dielectric 102 may be cylindrical, and the membrane 114 may be cylindrical). As shown in both FIGS. 1A and 1B, device 100 may include the dielectric 102 having the channel 104 defined therein that extends from the first end 106 of the dielectric 102 to the second end 108 of the dielectric 102. Also as illustrated in both FIGS. 1A and 1B, the first end 110 of the channel 104 may be located at the first end 106 of the dielectric 102 and the second end 112 of the channel 104 may be located at the second end 108 of the dielectric 102. Further, device 100 may include the membrane 114 located on the exterior side of the dielectric 102 such that the membrane 114 does not interface with the channel 104.

In FIG. 1B, the electric current is illustrated by the arrows within the membrane 114 near the interface between the membrane 114 and the dielectric 102. In some embodiments, the electric current may flow in the opposite direction depending on the direction of movement and/or the polarity of the minority carriers in the membrane 114.

In some embodiments, the channel 104 may be the same shape as the dielectric 102 (e.g., both the channel 104 and the dielectric 102 may both be cylinders). In some embodiments, the channel 104 may be a different shape from the dielectric 102 (e.g., the channel 104 may be a cylinder while the dielectric 102 may be a cube). Similarly, in some embodiments, the channel 104 may be the same shape as the membrane 114. In some embodiments, the channel 104 may be a different shape from the membrane 114.

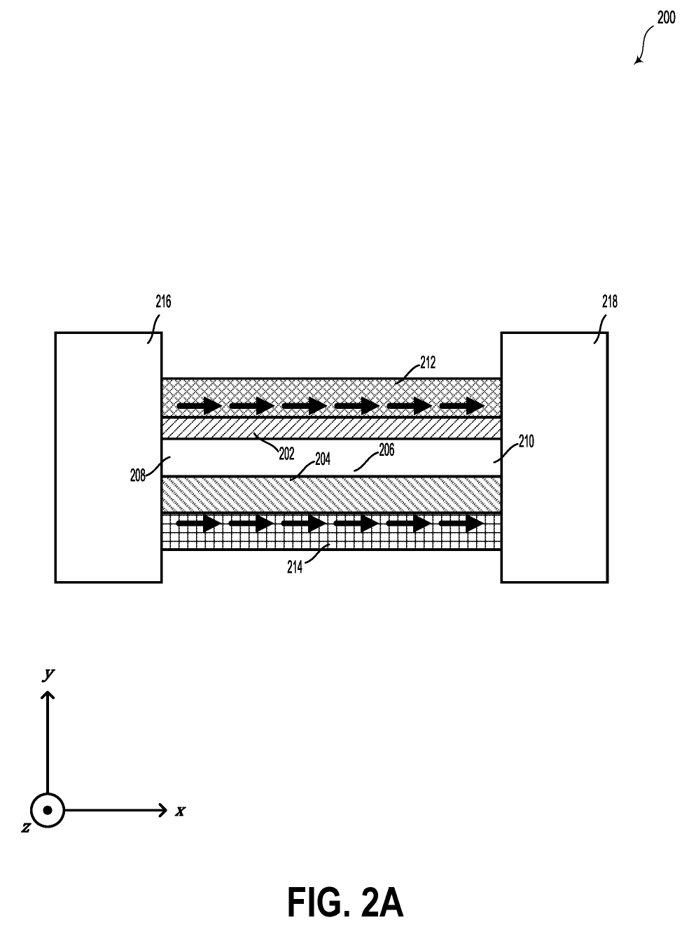

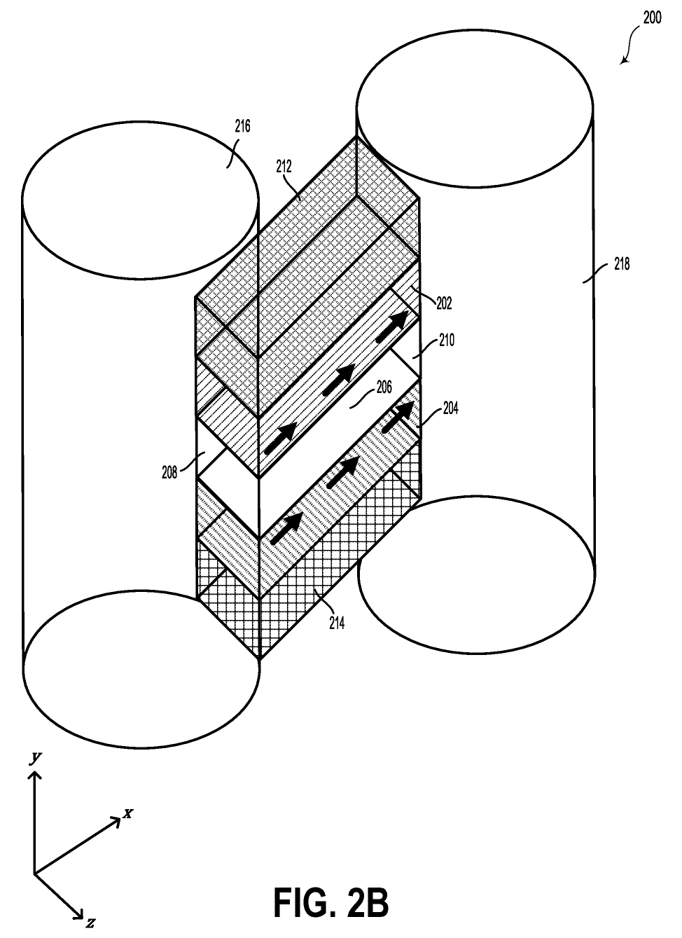

While device 100 shown and described with reference to FIGS. 1A and 1B may include a cylindrical dielectric 102, a cylindrical channel 104, and a cylindrical membrane 114, other embodiments are also possible and are contemplated herein. One such embodiment is a planar device, such as device 200 shown and described with reference to FIGS. 2A-2B. Other example embodiments are shown in FIGS. 1C-1F.

FIG. 1C is an isometric illustration of the device 100 of FIG. 1A, according to example embodiments. As shown in FIG. 1C, device 100 may have a dielectric 102, a channel 104, and a membrane 114. As illustrated in FIG. 1C, none of device 100, the dielectric 102, the channel 104, or the membrane 114 is straight. In some embodiments, device 100, the dielectric 102, the channel 104, and/or the membrane 114 may be bent (e.g., may include one or more bends). Such a bend may allow device 100, the dielectric 102, the channel 104, and/or the membrane 114 to be more compact.

FIG. 1D is an isometric illustration of the device 100 of FIG. 1A, according to example embodiments. As shown in FIG. 1D, device 100 may have a dielectric 102, a channel 104, and a membrane 114. As illustrated in FIG. 1D, device 100, the dielectric 102, the channel 104, and/or the membrane 114 may have a cross-section transverse to a longitudinal direction of device 100 such that there is no axis of cross-sectional symmetry passing through the center of the cross-section (e.g., an asymmetrically shaped cross-section). The term “cross-section,” as used herein, describes a planar slice along plane of the device that is parallel to the y-z plane illustrated in FIG. 1D. The shape of the device of FIG. 1D is provided as an example and other asymmetric shapes are also possible.

FIG. 1E is an isometric illustration of the device 100 of FIG. 1A, according to example embodiments. As shown in FIG. 1E, device 100 may have a dielectric 102, a channel 104, and a membrane 114. In some embodiments, device 100, the dielectric 102, the channel 104, and/or the membrane 114 may have a cross-section transverse to a longitudinal direction of device 100 such that there is one axis of cross-sectional symmetry passing through the center of the cross-section (e.g., a kite-shaped cross-section). One such example is shown in FIG. 1E, where the cross-section is trapezoid-shaped.

In some embodiments, device 100, the dielectric 102, the channel 104, and/or the membrane 114 may have a cross-section transverse to the longitudinal direction of device 100 such that there are two axes of cross-sectional symmetry passing through the center of the cross-section (e.g., an elliptical cross-section, a rectangular cross-section, etc.).

FIG. 1F is an isometric illustration of the device 100 of FIG. 1A, according to example embodiments. As shown in FIG. 1F, device 100 may have a dielectric 102, a channel 104, and a membrane 114. In some embodiments, device 100, the dielectric 102, the channel 104, and/or the membrane 114 may have a cross-section transverse to the longitudinal direction of device 100 such that there are three or more axes of cross-sectional symmetry passing through the center of the cross-section (e.g., a square cross-section, a hexagonal cross-section, a pentagonal cross-section, etc.). One such example is shown in FIG. 1F, where the cross-section is square-shaped.

FIG. 1G is an isometric illustration of the device 100 of FIG. 1A, according to example embodiments. As shown in FIG. 1G, device 100 may have a dielectric 102, a channel 104, and a membrane 114 (e.g., a dielectric 102, a channel 104, and a membrane 114 that each have circularly shaped cross-sections). The dielectric 102 may have a height 120 and a thickness 122. In some embodiments, the height 120 of the dielectric may range from approximately 1 nm to approximately 500 nm. In some embodiments, the thickness 122 of the dielectric may range from approximately 0.3 nm to approximately 0.8 nm. In some embodiments, the thickness 122 may be the average (e.g., arithmetic mean, geometric mean, harmonic mean, median, mode) distance from the channel 104 to the membrane 114.

As shown in FIG. 1G, the channel 104 may have a thickness 124. In FIG. 1G, the thickness 124 is defined from the center of the channel 104 to the dielectric 102 (e.g., the radius of the cylinder). In some embodiments, the thickness 124 may be the average (e.g., arithmetic mean, geometric mean, harmonic mean, median, mode) distance from the center of the channel 104 to the dielectric 102.

In some embodiments, the thickness 124 of the channel 104 may range from approximately 0.5 nm to approximately 5 nm. In some embodiments, the thickness 124 of the channel 104 may vary along a length of the channel (i.e., different regions of the channel may have different thicknesses). By reducing the thickness 124 of the channel 104, the speed of the liquid within the channel 104 may increase due to Bernoulli’s Principle.

As shown in FIG. 1G, the membrane 114 may have a thickness 126. In some embodiments, the thickness 126 of the membrane may range from approximately 1 nm to approximately 500 nm.

In some embodiments, a cross-section transverse to a longitudinal direction of device 100 may be elliptically shaped, circularly shaped, asymmetrically shaped, or rectangularly shaped. For example, FIG. 1B illustrates device 100 having a cross-section transverse to a longitudinal direction of device 100 that is circularly shaped. As another example, FIG. 1E illustrates device 100 having a cross-section transverse to the longitudinal direction of device 100 that is trapezoidally shaped. As yet another example, FIG. 1F illustrates device 100 having a cross-section transverse to the longitudinal direction of device 100 that is square-shaped.

In some embodiments, the electric current may be generated within the membrane 114 as a result of a transport of electrons. In some embodiments, the electric current may be generated with the membrane 114 as a result of a transport of holes.

In some embodiments, the dielectric 102 may have a thickness 122 of approximately 0.8 nm. In some embodiments, the dielectric 102 may be an oxide. In some embodiments, the dielectric 102 may have a dielectric constant between approximately 1 and approximately 5 (e.g., approximately 3.9). In some embodiments, the membrane 114 may have a dielectric constant between 5 and 15 (e.g., approximately 11.7).

In some embodiments, the dielectric 102 may have a dielectric constant that is greater than or equal to a geometric mean of a dielectric constant of the membrane 114 and a dielectric constant of the fluid.

In some embodiments, the membrane 114 may include silicon, graphene with hexagonal boron nitride (h-BN) layers, transition metal dichalcogenides, silicon carbide, calcium fluoride (CaF₂), a combination of silicon and germanium, manganese dioxide (MnO₂), or hafnium oxide (HfO₂).

In some embodiments, the membrane 114 may include graphene. In some embodiments, device 100 may include an auxiliary membrane located on an opposite side of the membrane 114 from the dielectric 102. In some embodiments, the auxiliary membrane may include poly(methyl methacrylate) (PMMA). In some embodiments, the dielectric 102 may include h-BN.

In some embodiments, the membrane 114 may be a conductor or a semiconductor. In semiconductor embodiments, the membrane 114 may be doped with an acceptor doping concentration of between approximately 10¹⁵ and approximately 10¹⁷ atoms per cubic centimeter. In some embodiments, the dielectric may be replaced with an insulator.

FIG. 2A is a cross-sectional illustration of a device 200, according to example embodiments. Device 200 may include a first dielectric 202 and a second dielectric 204 separated from the first dielectric 202 by a distance defining a channel 206. The channel 206 may run from a first end 208 to a second end 210 of the channel 206. Device 200 may include a first membrane 212, located on an exterior side of the first dielectric 202 such that the first membrane 212 does not interface with the channel 206. Device 200 may also include a second membrane 214 located on an exterior side of the second dielectric 204 such that the second membrane 214 does not interface with the channel 206. Moreover, device 200 may include a first chamber 216 fluidly coupled to the first end 208 of the channel 206 and a second chamber 218 fluidly coupled to the second end 210 of the channel 206. In addition, when a fluid distributed among the first chamber 216, the channel 206, and the second chamber 218 exhibits an ionic concentration gradient between the first chamber 216 and the second chamber 218 resulting in an ionic flow (e.g., diffusion flow), an electric current may be generated within the first membrane 212 or the second membrane 214. In FIG. 2A, the electric current is illustrated by the arrows within the membranes 212, 214 near the interfaces between the membranes 212, 214 and the corresponding dielectrics 202, 204. In some embodiments, the electric current may flow in the opposite direction depending on the direction of movement and/or the polarity of the minority carriers in the membranes 212, 214.

In some embodiments, the thickness of the first dielectric 202 could be different from the thickness of the second dielectric 204. Similarly, in some embodiments, the thickness of the first membrane 212 could be different from the thickness of the second membrane 214.

In some embodiments, a first end of the first dielectric 202 may be located at the first end 208 of the channel 206 and a second end of the first dielectric 202 may be located at the second end 210 of the channel 206. In some embodiments, a first end of the first membrane 212 may be located at the first end of the first dielectric 202 and a second end of the first membrane 212 may be located at the second end of the first dielectric 202. In some embodiments, device 200 may also include a first electrode electrically coupled to the first end of the first membrane 212 or the first end of the second membrane 214. In some embodiments, device 200 may also include a second electrode electrically coupled to the second end of the first membrane 212 or the second end of the second membrane 214. In some embodiments, when the electric current is generated within the first membrane 212 or the second membrane 214, a drag current and a drag voltage may be generated between the first electrode and the second electrode.

As noted above with respect to FIGS. 1C-1F, while device 100, the channel 104, the dielectric 102, and the membrane 114 are illustrated as cylinders with circular cross-sections in FIG. 1B, other shapes are also possible. Similarly, such shapes are possible for a cross-section of device 200 and/or a cross-section of the channel 206.

In some embodiments, the distance defining the channel 206 (e.g., the separation between the first dielectric 202 and the second dielectric 204) may be less than 5 nanometers.

In some embodiments, the first membrane 212 may have a dielectric constant of between 5 and 15 (e.g., approximately 12) and a bulk hole concentration of between approximately 10¹⁶ and approximately 10¹⁸ holes per cubic centimeter. In some embodiments, the first dielectric 202 may have a dielectric constant of between approximately 1 and approximately 5 (e.g., approximately 4). In some embodiments, the distance defining the channel 206 may be between approximately 5 and approximately 15 nanometers. In some embodiments, a thickness of the first dielectric 202 may be between approximately 0.3 nm and approximately 0.8 nm.

In some embodiments, the first dielectric 202 may have a dielectric constant that is approximately equal to a dielectric constant of the second dielectric 204. In some embodiments, the first membrane 212 may have a dielectric constant that is approximately equal to a dielectric constant of the second membrane 214. In some embodiments, the dielectric constant of the first dielectric 202 may be greater than or equal to a geometric mean of the dielectric constant of the first membrane 212 and a dielectric constant of the fluid.

In some embodiments, the first dielectric 202 may have a dielectric constant of approximately 3.9. In some embodiments, the first membrane 212 may have a dielectric constant of approximately 11.7. In some embodiments, the first membrane 212 may include silicon, graphene with h-BN layers, transition metal dichalcogenides, silicon carbide, CaF_{2,} MnO₂, or HfO₂.

FIG. 2B is an isometric illustration of the device 200 of FIG. 2A, according to example embodiments. As shown in FIG. 2B, device 200 may include a first dielectric 202 and a second dielectric 204 separated from the first dielectric 202 by a distance defining a channel 206. The channel 206 may run from a first end 208 to a second end 210 of the channel 206. Device 200 may include a first membrane 212, located on an exterior side of the first dielectric 202 such that the first membrane 212 does not interface with the channel 206. Device 200 may also include a second membrane 214 located on an exterior side of the second dielectric 204 such that the second membrane 214 does not interface with the channel 206. Moreover, device 200 may include a first chamber 216 fluidly coupled to the first end 208 of the channel 206 and a second chamber 218 fluidly coupled to the second end 210 of the channel 206. In addition, when a fluid distributed among the first chamber 216, the channel 206, and the second chamber 218 exhibits an ionic concentration gradient between the first chamber 216 and the second chamber 218 resulting in an ionic flow (e.g., diffusion flow), an electric current may be generated within the first membrane 212 or the second membrane 214. In FIG. 2B, the electric current is illustrated by the arrows within the membranes 212, 214 near the interfaces between the membranes 212, 214 and the corresponding dielectrics 202, 204.

As can be seen from FIG. 2B, membranes 212, 214 may be separate from each other. As can also be seen from FIG. 2B, dielectrics 202, 204 may be separate from each other.

Though only individual channels are shown in FIGS. 1A-2B, any of these channels may be integrated into a multi-channel device. Two example embodiments of such devices are described next.

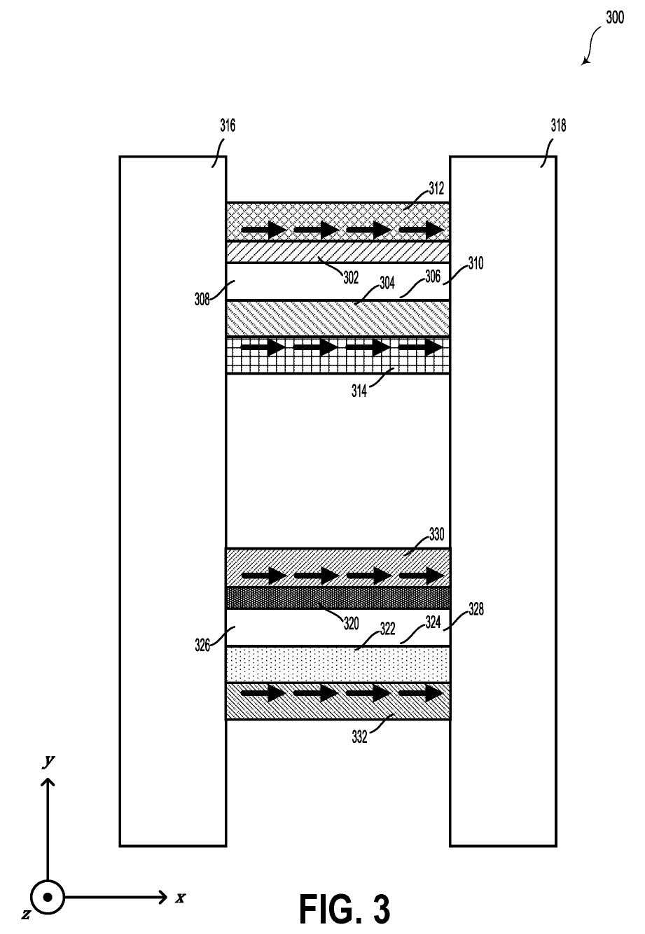

FIG. 3 is a cross-sectional illustration of a device 300, according to example embodiments. As depicted in FIG. 3, device 300 may include a first dielectric 302 and a second dielectric 304 separated from the first dielectric 302 by a distance defining a first channel 306. The first channel 306 may run from a first end 308 to a second end 310 of the first channel 306. Device 300 may include a first membrane 312, located on an exterior side of the first dielectric 302 such that the first membrane 312 does not interface with the first channel 306. Device 300 may also include a second membrane 314 located on an exterior side of the second dielectric 304 such that the second membrane 314 does not interface with the first channel 306.

In some embodiments, the thickness of the first dielectric 302 could be different from the thickness of the second dielectric 304. Similarly, in some embodiments, the thickness of the first membrane 312 could be different from the thickness of the second membrane 314.

As also depicted in FIG. 3, device 300 may include a third dielectric 320 and a fourth dielectric 322 separated from the third dielectric 320 by a distance defining a second channel 324. The second channel 324 may run from a first end 326 to a second end 328 of the second channel 324. Device 300 may include a third membrane 330, located on an exterior side of the third dielectric 320 such that the third membrane 330 does not interface with the second channel 324. Device 300 may also include a fourth membrane 332 located on an exterior side of the fourth dielectric 322 such that the fourth membrane 332 does not interface with the second channel 324.

In some embodiments, the thickness of the third dielectric 320 could be different from the thickness of the fourth dielectric 322. Similarly, in some embodiments, the thickness of the third membrane 330 could be different from the thickness of the fourth membrane 332.

Moreover, as shown in FIG. 3, device 300 may include a first chamber 316 fluidly coupled to the first end 308 of the first channel 306 and the first end 326 of the second channel 324. Device 300 may further include a second chamber 318 fluidly coupled to the second end 310 of the first channel 306 and the second end 328 of the second channel 324. When a fluid distributed among the first chamber 316, the first channel 306, the second channel 324, and the second chamber 318 exhibits an ionic concentration gradient between the first chamber 316 and the second chamber 318 resulting in an ionic flow (e.g., within the first channel 306 and/or the second channel 324), an electric current may be generated within the first membrane 312, the second membrane 314, the third membrane 330, and/or the fourth membrane 332. In FIG. 3, this electric current is illustrated by the arrows within the membranes 312, 314, 330, 332 near the interfaces between the membranes 312, 314, 330, 332 and the corresponding dielectrics 302, 304, 320, 322. In some embodiments, the electric current may flow in the opposite direction depending on the direction of movement and/or the polarity of the minority carriers in the membranes 312, 314, 330, 332.

In some embodiments, a first end of the first dielectric 302 may be located at the first end 308 of the first channel 306 and a second end of the first dielectric 302 may be located at the second end 310 of the first channel 306. Likewise, in some embodiments, a first end of the third dielectric 320 may be located at the first end 326 of the second channel 324 and a second end of the third dielectric 320 may be located at the second end 328 of the second channel 324. In some embodiments, a first end of the first membrane 312 may be located at the first end of the first dielectric 302 and a second end of the first membrane 312 may be located at the second end of the first dielectric 302. Likewise, in some embodiments, a first end of the third membrane 330 may be located at the first end of the third dielectric 320 and a second end of the third membrane 330 may be located at the second end of the third dielectric 320.

In some embodiments, a first end of the second dielectric 304 may be located at the first end 308 of the first channel 306 and a second end of the second dielectric 304 may be located at the second end 310 of the first channel 306. Likewise, in some embodiments, a first end of the fourth dielectric 322 may be located at the first end 326 of the second channel 324 and a second end of the fourth dielectric 322 may be located at the second end 328 of the second channel 324. In some embodiments, a first end of the second membrane 314 may be located at the first end of the second dielectric 304 and a second end of the second membrane 314 may be located at the second end of the second dielectric 304. Likewise, in some embodiments, a first end of the fourth membrane 332 may be located at the first end of the fourth dielectric 322 and a second end of the fourth membrane 332 may be located at the second end of the fourth dielectric 322.

In some embodiments, device 300 may also include a first electrode electrically coupled to the first end of the first membrane 312, the first end of the second membrane 314, the first end of the third membrane 330, or the first end of the fourth membrane 332. In such embodiments, device 300 may also include a second electrode electrically coupled to the second end of the first membrane 312, the second end of the second membrane 314, the second end of the third membrane 330, or the second end of the fourth membrane 332. In some embodiments, when the electric current is generated within the first membrane 312, the second membrane 314, the third membrane 330, or the fourth membrane 332, a drag current and a drag voltage may be generated between the first electrode and the second electrode.

In some embodiments, the first dielectric 302, the second dielectric 304, the first channel 306, the first membrane 312, and the second membrane 314 may be replaced by a cylindrical arrangement like the embodiment depicted in FIG. 1B. Additionally or alternatively, in some embodiments, the third dielectric 320, the fourth dielectric 322, the second channel 324, the third membrane 330, and the fourth membrane 332 may be replaced by a cylindrical arrangement like the embodiment depicted in FIG. 1B.

In some embodiments, multiple channels may be defined concentrically about one another. For example, a first cylindrical channel may be defined within a first cylindrical dielectric that is surrounded by a first cylindrical membrane (e.g., similar to the embodiment shown and described with reference to FIGS. 1A and 1B). Further, a second cylindrical dielectric may surround the first cylindrical membrane and a third cylindrical dielectric may surround the second cylindrical dielectric. The third cylindrical dielectric may be separated radially from the second cylindrical dielectric so as to define a second cylindrical channel (e.g., an annular channel when viewed in cross-section). Finally, a second cylindrical membrane may surround the third cylindrical dielectric. Other arrangements of dielectrics, membranes, and channels are also possible.

Device 300 may provide an increased flow between the first chamber 316 and the second chamber 318 and an increased electric current in membranes 312, 314, 330, 332. Additionally, device 300 may provide redundancy. For example, if the first channel 306 is blocked, then no current may be generated in membranes 312, 314, but current may still be generated in membranes 330, 332. Likewise, if the second channel 324 is blocked, then no current may be generated in membranes 330, 332, but current may still be generated in membranes 312, 314. A further benefit is that the power extracted from the flow may increase as the number of channels in parallel increases, which may enable greater power extraction from the flow.

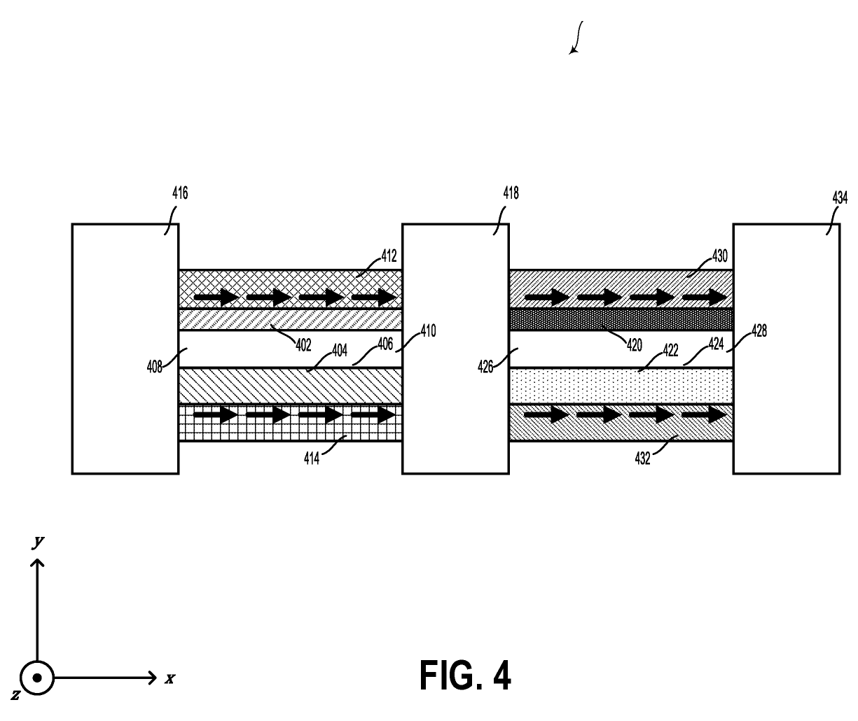

FIG. 4 is a cross-sectional illustration of a device 400, according to example embodiments. As depicted in FIG. 4, device 400 may include a first dielectric 402 and a second dielectric 404 separated from the first dielectric 402 by a distance defining a first channel 406. The first channel 406 may run from a first end 408 to a second end 410 of the first channel 406. Device 400 may include a first membrane 412, located on an exterior side of the first dielectric 402 such that the first membrane 412 does not interface with the first channel 406. Device 400 may also include a second membrane 414 located on an exterior side of the second dielectric 404 such that the second membrane 414 does not interface with the first channel 406.

In some embodiments, the thickness of the first dielectric 402 could be different from the thickness of the second dielectric 404. Similarly, in some embodiments, the thickness of the first membrane 412 could be different from the thickness of the second membrane 414.

As also depicted in FIG. 4, device 400 may include a third dielectric 420 and a fourth dielectric 422 separated from the third dielectric 420 by a distance defining a second channel 424. The second channel 424 may run from a first end 426 to a second end 428 of the second channel 424. Device 400 may include a third membrane 430, located on an exterior side of the third dielectric 420 such that the third membrane 430 does not interface with the second channel 424. Device 400 may also include a fourth membrane 432 located on an exterior side of the fourth dielectric 422 such that the fourth membrane 432 does not interface with the second channel 424.

In some embodiments, the thickness of the third dielectric 420 could be different from the thickness of the fourth dielectric 422. Similarly, in some embodiments, the thickness of the third membrane 430 could be different from the thickness of the fourth membrane 432.

Moreover, as shown in FIG. 4, device 400 may include a first chamber 416 fluidly coupled to the first end 408 of the first channel 406. Device 400 may further include a second chamber 418 fluidly coupled to the second end 410 of the first channel 406 and the first end 426 of the second channel 424. When a fluid distributed among the first chamber 416, the first channel 406, and the second chamber 418 exhibits an ionic concentration gradient between the first chamber 416 and the second chamber 418 resulting in an ionic flow, an electric current may be generated within the first membrane 412 or the second membrane 414.

Further, device 400 may include a third chamber 434 fluidly coupled to the second end 428 of the second channel 424. When a fluid distributed among the second chamber 418, the second channel 424, and the third chamber 434 exhibits an ionic concentration gradient between the second chamber 418 and the third chamber 434 resulting in an ionic flow, an electric current may be generated within the third membrane 430 or the fourth membrane 432.

In FIG. 4, the electric current in membranes 412, 414, 430, 432 is illustrated by the arrows within the membranes 412, 414, 430, 432 near the interfaces between the membranes 412, 414, 430, 432 and the corresponding dielectrics 402, 404, 420, 422. In some embodiments, the electric current may flow in the opposite direction depending on the direction of movement and/or the polarity of the minority carriers in the membranes 412, 414, 430, 432.

In some embodiments, a first end of the first dielectric 402 may be located at the first end 408 of the first channel 406 and a second end of the first dielectric 402 may be located at the second end 410 of the first channel 406. Likewise, in some embodiments, a first end of the third dielectric 420 may be located at the first end 426 of the second channel 424 and a second end of the third dielectric 420 may be located at the second end 428 of the second channel 424. In some embodiments, a first end of the first membrane 412 may be located at the first end of the first dielectric 402 and a second end of the first membrane 412 may be located at the second end of the first dielectric 402. Likewise, in some embodiments, a first end of the third membrane 430 may be located at the first end of the third dielectric 420 and a second end of the third membrane 430 may be located at the second end of the third dielectric 420.

In some embodiments, a first end of the second dielectric 404 may be located at the first end 408 of the first channel 406 and a second end of the second dielectric 404 may be located at the second end 410 of the first channel 406. Likewise, in some embodiments, a first end of the fourth dielectric 422 may be located at the first end 426 of the second channel 424 and a second end of the fourth dielectric 422 may be located at the second end 428 of the second channel 424. In some embodiments, a first end of the second membrane 414 may be located at the first end of the second dielectric 404 and a second end of the second membrane 414 may be located at the second end of the second dielectric 404. Likewise, in some embodiments, a first end of the fourth membrane 432 may be located at the first end of the fourth dielectric 422 and a second end of the fourth membrane 432 may be located at the second end of the fourth dielectric 422.

In some embodiments, device 400 may also include a first electrode electrically coupled to the first end of the first membrane 412, the first end of the second membrane 414, the first end of the third membrane 430, or the first end of the fourth membrane 432. In such embodiments, device 400 may also include a second electrode electrically coupled to the second end of the first membrane 412, the second end of the second membrane 414, the second end of the third membrane 430, or the second end of the fourth membrane 432. In some embodiments, when the electric current is generated within the first membrane 412, the second membrane 414, the third membrane 430, or the fourth membrane 432, a drag current and a drag voltage may be generated between the first electrode and the second electrode. Pairs of electrodes may be placed on opposing ends of each of the first membrane 412, the second membrane 414, the third membrane 430, and the fourth membrane 432, or any subset thereof, at the same time.

In some embodiments, the first dielectric 402, the second dielectric 404, the first channel 406, the first membrane 412, and the second membrane 414 may be replaced by a cylindrical arrangement like the embodiment depicted in FIG. 1B. Additionally or alternatively, in some embodiments, the third dielectric 420, the fourth dielectric 422, the second channel 424, the third membrane 430, and the fourth membrane 432 may be replaced by a cylindrical arrangement like the embodiment depicted in FIG. 1B.

The device 400 may provide variable electric current generation across membranes 412, 414, 430, 432 through control of the relative concentrations of ions in chambers 416, 418, 434. The voltage difference across the channels may increase with the number of channels placed in series, which may, thereby, increase the amount of power extracted from the flow.

Membranes 114, 212, 214, 312, 314, 330, 332, 412, 414, 430, 432, may each include the same materials as one another. Alternatively, membranes 114, 212, 214, 312, 314, 330, 332, 412, 414, 430, 432 may each include different materials from one another. In still other embodiments, some of membranes 114, 212, 214, 312, 314, 330, 332, 412, 414, 430, 432 may include different materials from one another.

In some embodiments, device 100, device 200, device 300, or device 400 may include metallic membranes or semi-metallic membranes (e.g., membranes 114, 212, 214, 312, 314, 330, 332, 412, 414, 430 in FIGS. 1A-4 may be carbon nanotube membranes).

### III. Example Methods

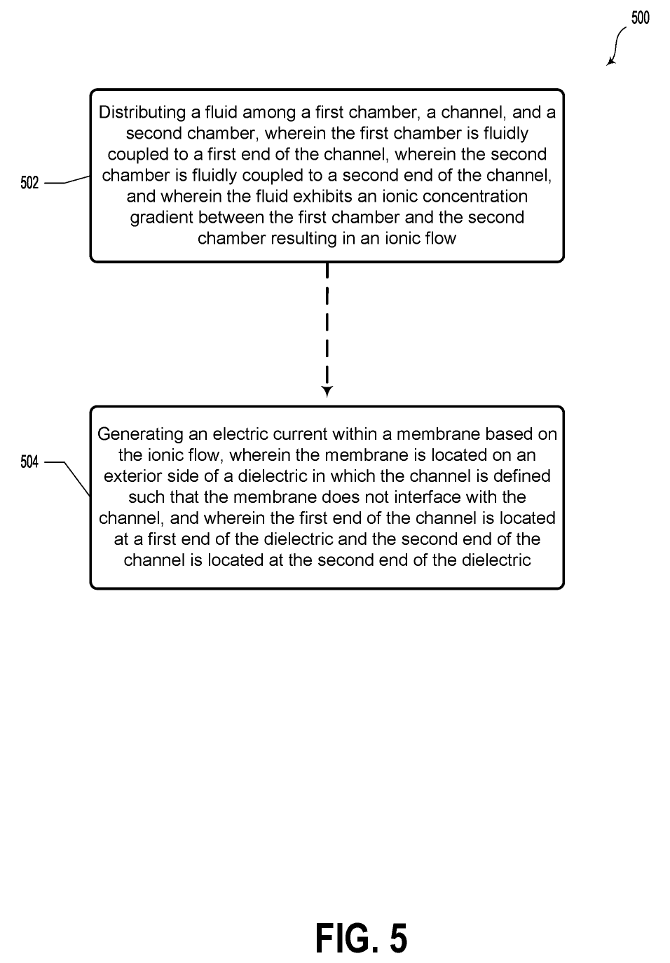

Turning now to FIG. 5. FIG. 5 is a flowchart illustration of a method 500, according to example embodiments. Method 500 may be performed using a device (e.g., device 100 shown and described with reference to FIGS. 1A -1G, device 200 shown and described with reference to FIGS. 2A-2B, device 300 shown and described with reference to FIG. 3, or device 400 shown and described with reference to FIG. 4).

At block 502, method 500 may include distributing a fluid among a first chamber, a channel, and a second chamber, wherein the first chamber is fluidly coupled to a first end of the channel, wherein the second chamber is fluidly coupled to a second end of the channel, and wherein the fluid exhibits an ionic concentration gradient between the first chamber and the second chamber resulting in an ionic flow.

At block 504, method 500 may include generating an electric current within a membrane based on the ionic flow, wherein the membrane is located on an exterior side of a dielectric in which the channel is defined such that the membrane does not interface with the channel, and wherein the first end of the channel is located at a first end of the dielectric and the second end of the channel is located at the second end of the dielectric.

In some embodiments, method 500 may also include extracting power from the electric current using a first electrode electrically coupled to a first end of the membrane and a second electrode electrically coupled to a second end of the membrane, wherein the first end of the membrane is located at the first end of the dielectric and the second end of the membrane is located at the second end of the dielectric..

In some embodiments, method 500 may also include adjusting a property of the membrane, wherein adjusting the property of the membrane comprises adjusting a gating of the membrane, a doping of the membrane, a temperature of the membrane, a potential of hydrogen (pH) of the membrane, or light received by the membrane, and wherein adjusting the property of the membrane results in a modulation of the ionic flow or the electric current. In some embodiments, adjusting one or more of these properties may enhance or reduce the ionic flow and/or the electric current (e.g., to set the ionic flow and/or electric current to a particular value).

In some embodiments, the gating of the membrane may be adjusted by controlling the flow of current through the membrane via the application of an external electric field. For example, the application of such an external electric field to a portion of the membrane may increase or decrease the density of charge carriers within a region of that portion of the membrane in proportion to the strength of the electric field. Increasing or decreasing the density of charge carriers within that region may affect the conductivity within that region of the membrane or throughout the entirety of the membrane. In this way, the conductivity of the membrane may be tuned through adjustments of the external electric field.

In some embodiments, the membrane may be doped. In such cases, the doping of the membrane may be adjusted by adjusting the bulk hole concentration of the dopant. In some embodiments, increasing the bulk hole concentration of the dopant may increase the conductivity of the membrane. In other embodiments, increasing the bulk hole concentration of the dopant may decrease the conductivity of the membrane. In yet further embodiments, increasing the bulk hole concentration of the dopant may have non-linear effects on the conductivity of the membrane (e.g., the conductivity may initially increase as the bulk hole concentration of the dopant increases but then decrease above a certain bulk hole concentration).

In some embodiments, the temperature of the membrane may be adjusted through adjusting the absorption by the membrane of heat emitted by an external device (e.g., a heater) adjacent to the membrane. In some embodiments, increasing the temperature of the membrane may increase the conductivity of the membrane. In other embodiments, increasing the temperature of the membrane may decrease the conductivity of the membrane. In yet further embodiments, increasing the temperature of the membrane may have non-linear effects on the conductivity of the membrane (e.g., the conductivity may initially increase as temperature increases but then decrease above a certain temperature).

In some embodiments, the pH of the membrane may be adjusted by adjusting the temperature of the membrane. For example, when the temperature of the membrane is increased, the pH of the membrane may decrease. As another example, when the temperature of the membrane is increased, the pH of the membrane may increase.

In some embodiments, increasing the pH of the membrane may increase the conductivity of the membrane. In other embodiments, increasing the pH of the membrane may decrease the conductivity of the membrane. In yet further embodiments, increasing the pH of the membrane may have non-linear effects on the conductivity of the membrane (e.g., the conductivity may initially increase as pH increases but then decrease above a certain pH).

In some embodiments, the pH of the fluid could be adjusted.

In some embodiments, the light received by the membrane may be adjusted by adjusting the intensity or frequency of a light source near the membrane. In some embodiments, when the light received by the membrane is adjusted, the light received by the dielectric may be adjusted. In some embodiments, when the light received by the membrane is adjusted, the light received by the dielectric may not be adjusted.

In some embodiments, increasing the light received by the membrane may increase the conductivity of the membrane. In other embodiments, increasing the light received by the membrane may decrease the conductivity of the membrane. In yet further embodiments, increasing the light received by the membrane may have non-linear effects on the conductivity of the membrane (e.g., the conductivity may initially increase as light received by the membrane increases but then decrease above a certain point).

In some embodiments, method 500 may also include detecting the electric current within the membrane. Based on this detection, the existence of ions in the fluid, the ionic flow between the first chamber and the second chamber, and/or the ionic concentration gradient between the first chamber and the second chamber may be determined.

In addition to the advantages that have been described, it is also possible that there are still other advantages that are not currently recognized but which may become apparent at a later time. While various embodiments have been described, it will be apparent to those of ordinary skill in the art that many more embodiments and implementations are possible. Accordingly, the embodiments described herein are examples, not the only possible embodiments and implementations.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A device, comprising:
a dielectric having a channel defined therein that extends from a first end of the dielectric to a second end of the dielectric, wherein a first end of the channel is located at the first end of the dielectric and a second end of the channel is located at the second end of the dielectric;
a membrane located on an exterior side of the dielectric such that the membrane does not interface with the channel;
a first chamber fluidly coupled to the first end of the channel; and
a second chamber fluidly coupled to the second end of the channel, wherein, when a fluid distributed among the first chamber, the channel, and the second chamber exhibits an ionic concentration gradient between the first chamber and the second chamber resulting in an ionic flow, an electric current is generated within the membrane.

2. The device of claim 1,
wherein a first end of the membrane is located at the first end of the dielectric and a second end of the membrane is located at the second end of the dielectric, and
wherein the device further comprises:
a first electrode electrically coupled to the first end of the membrane; and
a second electrode electrically coupled to the second end of the membrane,
wherein, when the electric current is generated within the membrane, a drag current and a drag voltage are generated between the first electrode and the second electrode.

3. The device of claim 1, wherein the channel is cylindrical.

4. The device of claim 1, wherein a cross-section transverse to a longitudinal direction of the device is elliptically shaped, circularly shaped, asymmetrically shaped, or rectangularly shaped.

5. The device of claim 1, wherein the electric current is generated within the membrane as a result of a transport of electrons.

6. The device of claim 1, wherein the dielectric has a thickness of approximately 0.8 nanometers, wherein the dielectric is an oxide and has a dielectric constant of approximately 3.9, and wherein the membrane is a semiconductor and has a dielectric constant of approximately 11.7.

7. The device of claim 1, wherein the dielectric has a dielectric constant that is greater than or equal to a geometric mean of a dielectric constant of the membrane and a dielectric constant of the fluid.

8. The device of claim 1, wherein the membrane comprises silicon, graphene with hexagonal boron nitride (h-BN) layers, transition metal dichalcogenides, silicon carbide, calcium fluoride (CaF₂), manganese dioxide (MnO₂), or hafnium oxide (HfO₂).

9. The device of claim 1, wherein the membrane comprises graphene, wherein the device further comprises an auxiliary membrane located on an opposite side of the membrane from the dielectric, wherein the auxiliary membrane comprises poly(methyl methacrylate) (PMMA), and wherein the dielectric comprises hexagonal boron nitride (h-BN).

10. The device of claim 1, wherein the channel is bent.

11. The device of claim 1, wherein the membrane is a conductor or semiconductor.

12. The device of claim 11, wherein the membrane is doped with an acceptor doping concentration of approximately 10¹⁷ atoms per cubic centimeter.

13. A device, comprising:
a first dielectric;
a second dielectric separated from the first dielectric by a distance defining a channel, wherein the channel runs from a first end to a second end;
a first membrane located on an exterior side of the first dielectric such that the first membrane does not interface with the channel;
a second membrane located on an exterior side of the second dielectric such that the second membrane does not interface with the channel;
a first chamber fluidly coupled to the first end of the channel; and
a second chamber fluidly coupled to the second end of the channel, wherein, when a fluid distributed among the first chamber, the channel, and the second chamber exhibits an ionic concentration gradient between the first chamber and the second chamber resulting in an ionic flow, an electric current is generated within the first membrane or the second membrane.

14. The device of claim 13,
wherein a first end of the first dielectric is located at the first end of the channel and a second end of the first dielectric is located at the second end of the channel, and
wherein a first end of the first membrane is located at the first end of the first dielectric and a second end of the first membrane is located at the second end of the first dielectric, and
wherein the device further comprises:
a first electrode electrically coupled to the first end of the first membrane; and
a second electrode electrically coupled to the second end of the first membrane,
wherein, when the electric current is generated within the first membrane, a drag current and a drag voltage are generated between the first electrode and the second electrode.

15. The device of claim 13, wherein the distance defining the channel is less than 5 nanometers.

16. The device of claim 13, wherein the first membrane has a dielectric constant of approximately 12 and a bulk hole concentration of approximately 10¹⁷ holes per cubic centimeter, wherein the first dielectric has a dielectric constant of approximately 4, wherein the distance defining the channel is approximately 1.34 nanometers, and wherein a thickness of the first dielectric is approximately 0.8 nanometers.

17. The device of claim 13, wherein the first dielectric has a dielectric constant that is approximately equal to a dielectric constant of the second dielectric, wherein the first membrane has a dielectric constant that is approximately equal to a dielectric constant of the second membrane, and wherein the dielectric constant of the first dielectric is greater than or equal to a geometric mean of the dielectric constant of the first membrane and a dielectric constant of the fluid.

18. A method comprising:
distributing a fluid among a first chamber, a channel, and a second chamber, wherein the first chamber is fluidly coupled to a first end of the channel, wherein the second chamber is fluidly coupled to a second end of the channel, and wherein the fluid exhibits an ionic concentration gradient between the first chamber and the second chamber resulting in an ionic flow; and
generating an electric current within a membrane based on the ionic flow, wherein the membrane is located on an exterior side of a dielectric in which the channel is defined such that the membrane does not interface with the channel, and wherein the first end of the channel is located at a first end of the dielectric and the second end of the channel is located at the second end of the dielectric.

19. The method of claim 18, further comprising extracting power from the electric current using a first electrode electrically coupled to a first end of the membrane and a second electrode electrically coupled to a second end of the membrane, wherein the first end of the membrane is located at the first end of the dielectric and the second end of the membrane is located at the second end of the dielectric.

20. The method of claim 18, further comprising adjusting a property of the membrane, wherein adjusting the property of the membrane comprises adjusting a gating of the membrane, a doping of the membrane, a temperature of the membrane, a pH of the membrane, or light received by the membrane, and wherein adjusting the property of the membrane results in a modulation of the ionic flow or the electric current.
